(19) United States
(12) Patent Application Publication
(10) Pub. No.: US 2014/0169685 A1
(43) Pub. Date: Jun. 19, 2014

(54) METHOD OF ENHANCING AN IMAGE MATCHING RESULT USING AN IMAGE CLASSIFICATION TECHNIQUE

(71) Applicant: NATIONAL CENTRAL UNIVERSITY, Taoyuan County (TW)

(72) Inventors: Liang-Chien Chen, Taoyuan County (TW); Yu-Yuan Chen, New Taipei City (TW); Wen-Chi Chang, New Taipei City (TW)

(73) Assignee: National Central University, Taoyuan County (TW)

(21) Appl. No.: 13/869,444

(22) Filed: Apr. 24, 2013

(30) Foreign Application Priority Data
Dec. 14, 2012 (TW) 101147419

(51) Int. Cl. G06K 9/62

(52) U.S. Cl. CPC G06K 9/6201
USPC 382/218

(57) ABSTRACT

A method of enhancing an image matching result using an image classification technique is disclosed, comprising the steps of acquiring relatively significantly hidden ones of a plurality of high overlapped close-range images; classifying each of the high overlapped close-range images to obtain a set of overall spectrum difference information over a multiple-spectra range; introducing a local gray level to each of the classified high overlapped close-range images to apply an integrated image matching; and evaluating a matching index by a threshold according to at least two similarity indexes to obtain a 3-dimensional point cloud coordinate position of a conjugate point for each of such images.

### FIELD OF THE INVENTION

The present invention relates to image matching; more particularly, relates to enhancing an image matching result by considering a feature with the overall spectrum difference in images.

### DESCRIPTION OF THE RELATED ART

In general, image matching is to locate conjugated points in different images, in which the conjugated points may be used to relate different images to obtain a position of an object in a 3-dimensional space.

For the conventional image matching technique, area-based and feature-based matching methods are included. The area-based matching, for example, Normalized Cross-Correlation, NCC [Pratt,1991], is applied by using local image block gray levels to locate corresponding objects among images. On the other hand, the feature-based matching is conducted by comparing differences of the local gray levels and considering the information such as shape and outline of a feature.

In an image matching process, if only similarity between features is compared, ambiguity is apt to happen. Han and park [2000] suggested a technique to promote accuracy of the image matching process by introducing epipolor geometry to further limit a matching range. In the case of separate sheets of images, Otto and Chau [1989] suggested Geometrically Constrained Cross-Correlation, GC3 to achieve accuracy of object location by using a set of satellite images on the same flying band.

However, although the conventional image matching technique uses images with multiple-spectra, it is still processed under being viewed as a separate single frequency band and thus the local image gray levels in a single frequency band base are used. In this manner, similarity of images is compared and through which corresponding points among images are located. However, the images are often accompanied with a ‘being-hidden’ issue, which brings about a matching error, although hidden information with regard to different angles for multiple images can be acquired.

Hence, the prior arts do not fulfill all users' requests on actual use.

### SUMMARY OF THE INVENTION

The main purpose of the present invention is to enhance quality and reliability of image matching, in which overall spectrum difference of a feature in the images are considered and the overall spectrum difference obtained from the image classification may increase a condition of similarity evaluation.

To achieve the above purpose, the present invention is a method of enhancing an image matching result using an image classification technique, comprising steps of: (a) acquiring high overlapped close-range images; (b) classifying each of the acquired high overlapped close-range images to obtain a set of overall spectrum difference information over a multiple-spectra range; (c) introducing a local gray level to each of the classified high overlapped close-range images to apply an integrated image matching; and (d) evaluating a matching index by a threshold according to at least two similarity indexes to obtain a 3-dimensional point cloud coordinate position of a conjugate point for each of the classified high overlapped close-range images.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a schematic flowchart of an image matching process according to the present invention;

FIG. 2 is a schematic diagram of multiple image classifications according to the present invention; and

FIG. 3 is a schematic diagram of evaluation of classification similarity according to the present invention.

### DESCRIPTION OF THE PREFERRED EMBODIMENT

The following description of the preferred embodiment is provided to understand the features and the structures of the present invention.

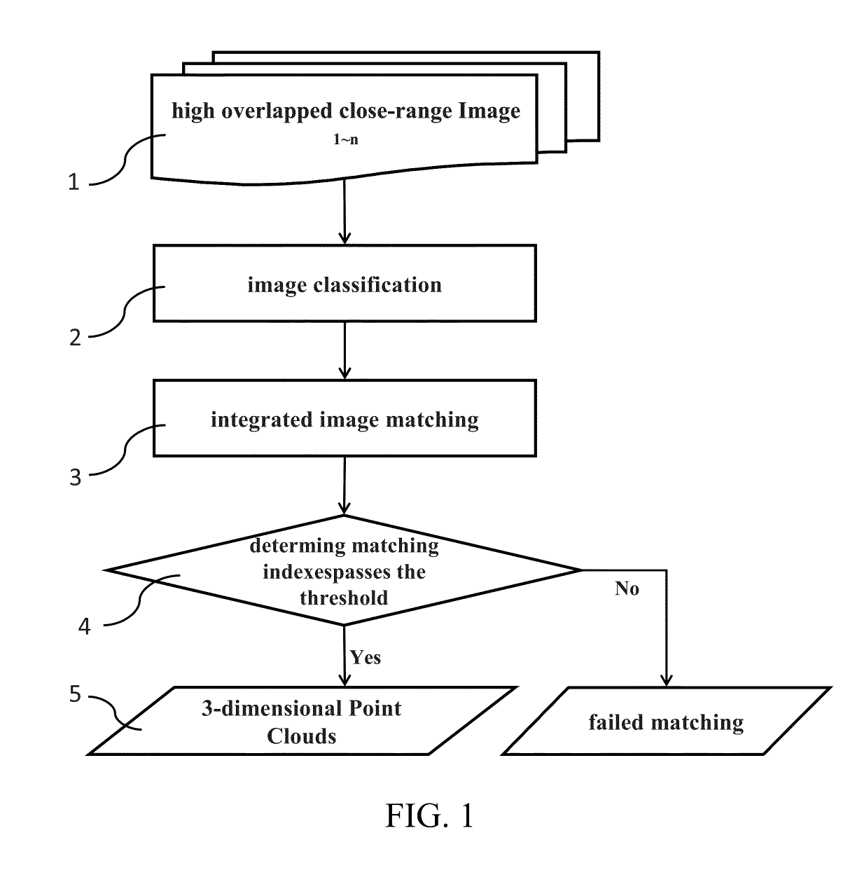

Please refer to FIG. 1, which are a schematic flowchart of an image matching process, a schematic diagram of multiple image classifications and a schematic diagram of evaluation of classification similarity according to the present invention. As shown in the figure, the present invention is a method of enhancing an image matching result using an image classification technique. In the method, the first step is acquiring relatively significantly hidden ones of a plurality of high overlapped close-range images (1).

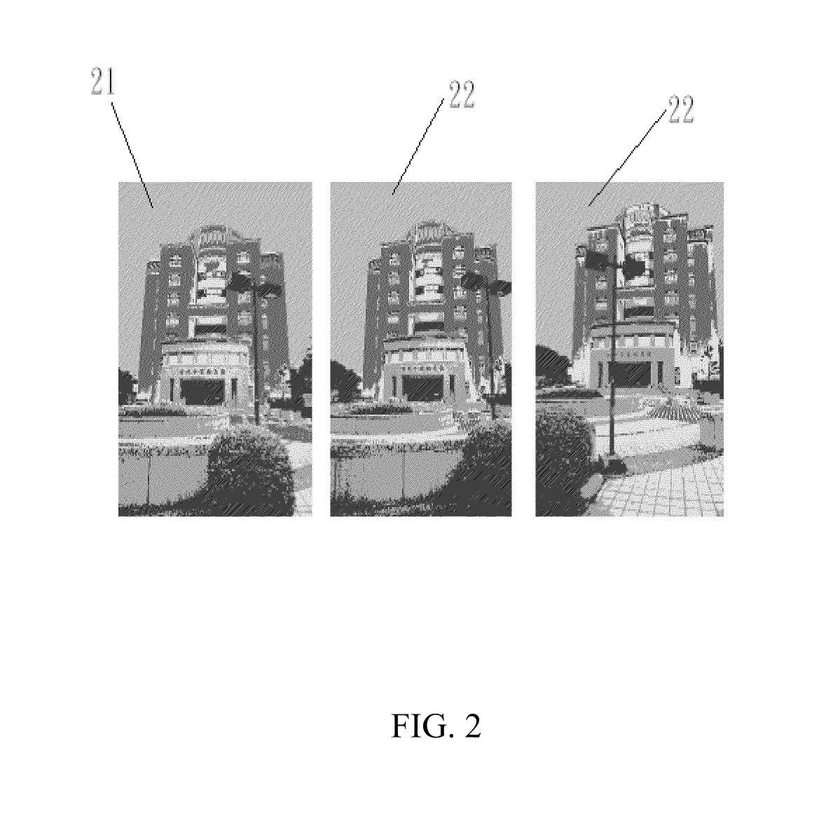

The second step is classifying each of the acquired high overlapped close-range images to obtain a set of overall spectrum difference information over a multiple-spectra range (2). In the classifying process, a non-supervision-based classification is applied onto a master image to obtain a block separation in the images. In the images, different object categories may be classified into different classifications. Then, a center value of the gray level of the classification is designated as a training area for each of the classified and acquired high overlapped close-range images. A supervision-based classification is applied onto a slave image to differentiate different blocks in each of the classified and acquired high overlapped close-range images according to the overall spectrum information, as shown in FIG. 2.

The third step is introducing a local gray level to each of the classified high overlapped close-range images to apply an integrated image matching (3).

After the third step (3), the fourth step (4) is performed, where at least two similarity indexes are used to evaluate whether a matching index pass a threshold, so as to obtain a 3-dimensional point cloud coordinate position of a conjugate point (5).

The similarity indexes include a gray level similarity and a classification similarity. In the case of classification similarity evaluation, a classification value of each of the classified high overlapped close-range images for pixels in a matching window is compared to one another to determine whether the classified high overlapped close-range images are in the same classification.

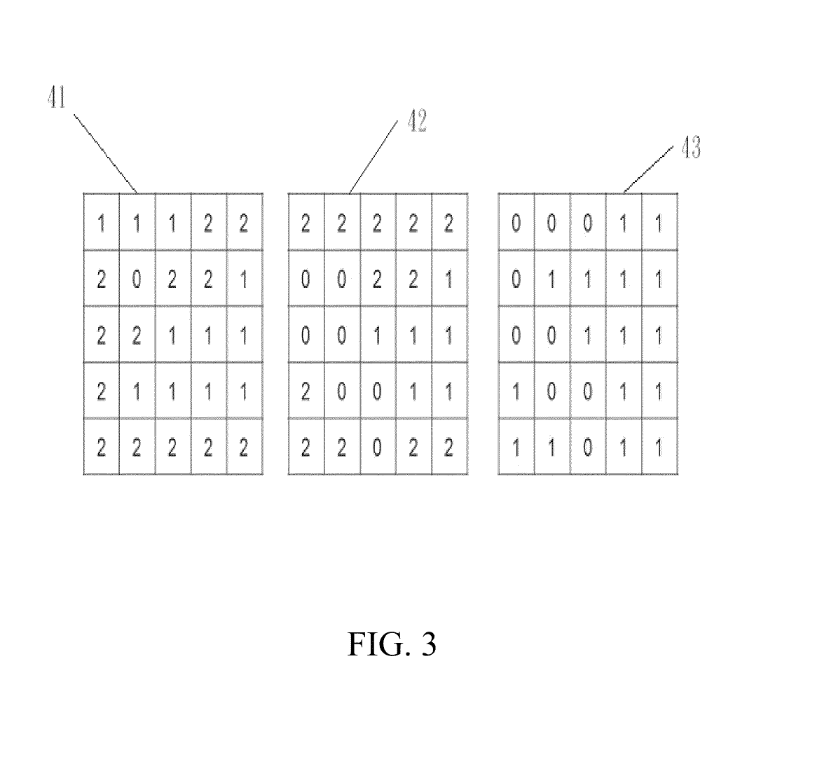

For each of the classified high overlapped close-range images, a number of the pixels having the same classification is calculated. Then, a ratio of the number of the pixels having the same respective classification to the number of the total pixels is calculated as a correlated coefficient, which is ranged between 0 and 1, shown in FIG. 3.

At first, for the classified high overlapped close-range images, a classification value of a master image classification (41) and a slave image classification (42) are matched to determine whether the master image classification (41) and the slave image classification (42) are in the same classification; and a match determination matrix (43) is accordingly generated. In the match determination matrix (43), 1 denotes where the same classification occurs, while 0 denotes where the same classification does not occur. Finally, a ratio of the number of the pixels having the same respective classification in the whole matrix (43) is calculated to serve as a correlated coefficient.

In this manner of image matching, conjugate points of a spatial coordinate of an object are obtained. And a 3-dimensional point cloud thus obtained can be used to describe an outlook of an object in the space. Therefore, the image matching method provided in the present invention may be extensively utilized on various image applications, such as pattern building and house detection.

By using the method of the present invention, when multiple images are matched, the overall spectrum difference of a feature for the high overlapped images are considered, which may increase a condition of evaluating similarity. Thus, quality and reliability of an image matching process are promoted. Therefore, the present invention can be deemed as more practical, improved and necessary to users.

The preferred embodiment(s) herein disclosed is(are) not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of enhancing an image matching result using an image classification technique, comprising steps of:
(a) acquiring r high overlapped close-range images;
(b) classifying each of the acquired high overlapped close-range images to obtain a set of overall spectrum difference information over a multiple-spectra range;
(c) introducing a local gray level to each of the classified high overlapped close-range images to apply an integrated image matching; and
(d) evaluating a matching index by a threshold according to at least two similarity indexes to obtain a 3-dimensional point cloud coordinate position of a conjugate point for each of the classified high overlapped close-range images.

2. The method according to claim 1, wherein step (b) is done by subjecting a non-supervision-based classification with related to a master image to obtain a block separation in each of the classified high overlapped close-range images and classifying different object categories into different classifications, and then designating a center value of the gray level of the classification as a training area for each of the classified high overlapped close-range images, and applying a supervision-based classification onto a slave image to differentiate different blocks in each of the classified high overlapped close-range images according to the overall spectrum information.

3. The method according to claim 1, wherein the similarity indexes include a gray level similarity and a classification similarity.

4. The method according to claim 3, wherein step (d) comprises a step of evaluating whether the matching index passes the threshold based on a pixel in a matching window by comparing a classification value of the classification of each of the classified high overlapped close-range images to determine whether the classified high overlapped close-range images have the same classification and calculating a number of the pixels having the same respective classification, and then calculating a ratio of the number of the pixels having the same respective classification to a number of the total pixels in the matching window as a correlated coefficient.
